(19) United States
(12) Patent Application Publication
(10) Pub. No.: US 2026/0122327 A1
(43) Pub. Date: Apr. 30, 2026

(54) IMAGING DEVICE

(71) Applicant: KOKUSAI DENKI Electric Inc., Minato-ku, Tokyo (JP)

(72) Inventors: Takuhiro SHIBUYA, Tokyo (JP); Shiro IKEDA, Tokyo (JP)

(21) Appl. No.: 19/159,931

(22) PCT Filed: Sep. 13, 2023
(86) PCT No.: PCT/JP2023/033292

§ 371 Date: Aug. 26, 2025

(30) Foreign Application Priority Data
Mar. 24, 2023 (JP) 2023-048054

(51) Int. Cl. H04N 23/16; G02B 5/30

(52) U.S. Cl. CPC H04N 23/16; G02B 5/3025

(57) ABSTRACT

An object is to provide multi-plate and single-plate color imaging devices each having a wide dynamic range and being capable of flexibly exercising light reduction control for each color while employing filters of a minimal configuration. The multi-plate imaging device includes: a movable polarization filter that polarizes incident light; a rotation mechanism that rotates the movable polarization filter with respect to an optical axis; and a fixed polarization filter installed at a prescribed angle on a front face of an image sensor that receives red light and blue light. The red light and the blue light are reduced according to a rotation angle of the movable polarization filter. The single-plate imaging device includes: a movable polarization filter that polarizes incident light; a rotation mechanism that rotates the movable polarization filter with respect to an optical axis; and an image sensor having a color Bayer array in which a polarization filter positioned at a prescribed angle is installed with red and blue color filters. Red light and blue light are reduced according to a rotation angle of the movable polarization filter.

### TECHNICAL FIELD

The present invention relates to an imaging device.

### BACKGROUND ART

Imaging devices for imaging a color picture include: multi-plate imaging devices using a color separation optical system and a plurality of monochrome image sensors; and a single-plate imaging devices using a single image sensor having a color Bayer array.

With those imaging devices, when a light source in an imaging environment has a low color temperature (e.g., the sunlight from a sunset, a halogen light, or the like) or has a high color temperature (e.g., the sunlight in daytime, a bluish Light Emitting Diode (LED) illumination, or the like), because the light amount of red or blue is large, it may turn out that the particular color component is saturated in a resulting picture.

By reducing incident light with the use of a lens limiter or the like, it is possible to keep a dynamic range without causing the color component having the large light amount to become saturated. However, because the light amounts of other color components would also be reduced, noise of those color components would increase at the time of supplementing lacking light amounts in an amplification circuit at a later stage. Accordingly, to prevent the increase in the noise, there is a demand for means for reducing the light amount for each color.

Known means for reducing the light amount for each color include using a Color Compensating (CC) filter realized with colored glass. The CC filter is capable of reducing a specific color component from incident light by employing a filter of a color suitable for an imaging environment and serves as means for obtaining a picture that is most natural.

Other known means include using a Neutral Density (ND) filter. In a multi-plate imaging device, an ND filter may be installed between a color separation optical system and an image sensor. In a single-plate imaging device, an ND filter may be installed for each of the color filters corresponding to different colors. In this manner, it is possible to appropriately reduce a specific color component having a large light amount.

Other known means include using a liquid crystal filter, which is a type of ND filter. When voltage is applied thereto, the liquid crystal filter is capable of achieving transmittance corresponding to the voltage. Having such a liquid crystal filter installed for each color makes it possible to flexibly exercise light reduction control in accordance with various imaging environments.

Other known means include using an electronic shutter function by which exposure period of an image sensor is controlled. The electronic shutter is capable of exercising light reduction control without the need to additionally install a device such as a filter and thus serves as advantageous means in terms of costs and space.

Patent Literature 1 discloses a multi-plate imaging device using a liquid crystal filter.

Further, Patent Literature 2 discloses a multi-plate imaging device using a liquid crystal filter and an amplifier.

In addition, Patent Literature 3 discloses a four-plate imaging device in which the light amount of red light is reduced by an ND filter, so as to make substantially equal the light amounts that become incident to image sensors.

### CITATION LIST

### Patent Literature

Patent Literature 1: Japanese Utility Model Laid-Open Publication No. 6-70386

Patent Literature 2: Japanese Patent Laid-Open Publication No. 2012-209674

Patent Literature 3: Japanese Patent Laid-Open Publication No. 7-250332

### SUMMARY OF INVENTION

### Technical Problem

When the means employing CC filters is used, it is necessary to provide the CC filters in a quantity corresponding to anticipated imaging environments and a mechanism that switches between the CC filters. Thus, problems related to a cost increase and installation space arise. Further, because colors of the CC filters are fixed, it is not possible to exercise seamless light reduction control, and the level of flexibility is inferior, too.

When the means employing ND filters is used, in a multi-plate imaging device, it is difficult, in terms of space, to install an ND filter switching mechanism for each image sensor. In a single-plate imaging device, it is also impossible to switch between the ND filters in units of pixels. Consequently, the light reduction amount for each color is fixed, and there is no flexibility at all.

When the means employing liquid crystal filters are used, in a multi-plate imaging device, it is necessary to provide a liquid crystal filter for each image sensor, which leads to an increase in costs. Furthermore, because liquid crystal filters are vulnerable to heat and ultraviolet rays, another problem arises where liquid crystal filters may be deteriorated quickly, when being installed inside an imaging device used outdoor or the like. Further, in a single-plate imaging device, it would be necessary to provide liquid crystal filters in a matrix formation matching the pixel size (a number of micrometers) of the image sensors. It is, however, difficult to manufacture this configuration with today's technology.

When the means using electronic shutters is used, a problem remains where, if the exposure period varies among the colors, afterimages occur in various amounts. Thus, an unnatural picture may turn out in which the afterimages are colored. Further, for generic image sensors, it is impossible to control electronic shutters in units of pixels. Thus, with single-plate imaging devices, the means using electronic shutters is not feasible.

It is an object of the present invention to provide multi-plate and single-plate color imaging devices each having a wide dynamic range and being capable of flexibly exercising light reduction control for each color while employing filters of a minimal configuration.

### Solution to Problem

To solve the problems presented above, a typical example of the multi-plate color imaging device of the present invention includes: a movable polarization filter that polarizes incident light; a rotation mechanism that rotates the movable polarization filter with respect to an optical axis; and a fixed polarization filter installed at a prescribed angle on a front face of an image sensor that receives red light and blue light. The red light and the blue light are reduced according to a rotation angle of the movable polarization filter.

Further, a typical example of the single-plate color imaging device of the present invention includes: a movable polarization filter that polarizes incident light; a rotation mechanism that rotates the movable polarization filter with respect to an optical axis; and an image sensor having a color Bayer array in which a polarization filter positioned at a prescribed angle is installed with red and blue color filters. Red light and blue light are reduced according to a rotation angle of the movable polarization filter.

### Advantageous Effects of Invention

The present invention makes it possible to flexibly exercise the light reduction control for each color while employing the filters of the minimal configuration and makes it possible to realize the multi-plate and single-plate color imaging devices each having a wide dynamic range.

Other problems, configurations, and advantageous effects besides those described above will become clear from the explanations in the section “Description of Embodiments” presented below.

### BRIEF DESCRIPTION OF DRAWINGS

FIG. 1 is a block diagram showing an exemplary configuration of a multi-plate imaging device according to a first embodiment.

FIG. 2A is a drawing showing a filter rotation mechanism in an example (where φ=−45°) .

FIG. 2B is a drawing showing the filter rotation mechanism in another example (where φ=0°) .

FIG. 2C is a drawing showing the filter rotation mechanism in yet another example (where φ=+45°) .

FIG. 3A is a drawing showing a different filter rotation mechanism in an example (where φ=−45°) .

FIG. 3B is a drawing showing the different filter rotation mechanism in another example (where φ=0°) .

FIG. 3C is a drawing showing the different filter rotation mechanism in yet another example (where φ=+45°) .

FIG. 4 is a drawing showing an example of reflection light reflected by a color separation optical system according to the first embodiment.

FIG. 5 is a drawing showing examples of polarization by a movable polarization filter and reflection light reflected by the color separation optical system according to the first embodiment.

FIG. 6 is a drawing showing a relationship, at θ=45°, between rotation angles of the movable polarization filter and light reduction amounts of red light and blue light.

FIG. 7 is a drawing showing a relationship, at θ=30°, between rotation angles of the movable polarization filter and light reduction amounts of red light and blue light.

FIG. 8 is a block diagram showing an exemplary configuration of a single-plate imaging device according to a second embodiment.

FIG. 9 is a drawing showing color filters and fixed polarization filters for an image sensor according to the second embodiment.

### DESCRIPTION OF EMBODIMENTS

The following will describe embodiments of the present invention in detail, with reference to the drawings. The present invention is not limited by the embodiments described below. Further, in depiction of the drawings, some of the elements that are the same are referred to by using the same reference characters.

### First Embodiment

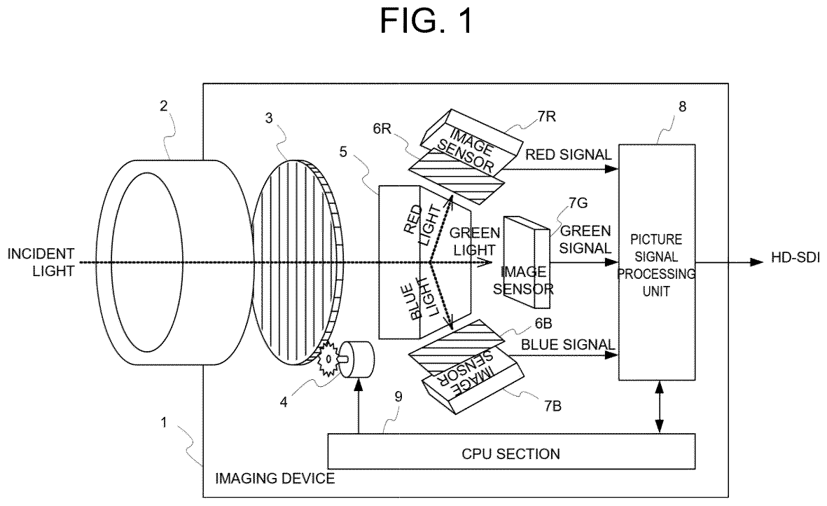

FIG. 1 is a block diagram showing an exemplary configuration of a multi-plate imaging device according to a first embodiment.

In FIG. 1, an imaging device 1 is structured with a lens 2, a movable polarization filter 3, a filter rotation mechanism 4, a color separation optical system 5, a fixed polarization filter 6R, a fixed polarization filter 6B, an image sensor 7R, an image sensor 7G, an image sensor 7B, a picture signal processing unit 8, and a Central Processing Unit (CPU) section 9. The image sensor 7R, the image sensor 7G, and the image sensor 7B are each a monochrome image sensor.

Incident light from an imaged subject is formed by the lens 2 into an image, which goes through the movable polarization filter 3, before being separated by the color separation optical system 5 into color light beams corresponding to red light, green light, and blue light. Of the separated color light beams, the red light is received by the image sensor 7R via the fixed polarization filter 6R; the green light is received by the image sensor 7G without intervention of any of the fixed polarization filters; and the blue light is received by the image sensor 7B via the fixed polarization filter 6B, before undergoing a photoelectric conversion into electrical signals. The picture signal processing unit 8 applies various types of signal processing processes on picture signals resulting from the photoelectric conversion, so that a picture signal output unit outputs a picture signal for a High Definition Serial Digital Interface (HD-SDI) or the like. The CPU section 9 is capable of controlling functional units of the imaging device 1.

The movable polarization filter 3 is structured to be rotatable by the filter rotation mechanism 4 in the range of −θ to +θ (where 0°<θ≤45°) with respect to an optical axis. The filter rotation mechanism 4 is controlled by the CPU section 9. Alternatively, an operation unit that enables manual rotation may be provided. Further, to control the rotation angles more precisely, it is also acceptable to provide reading means such as a potentiometer.

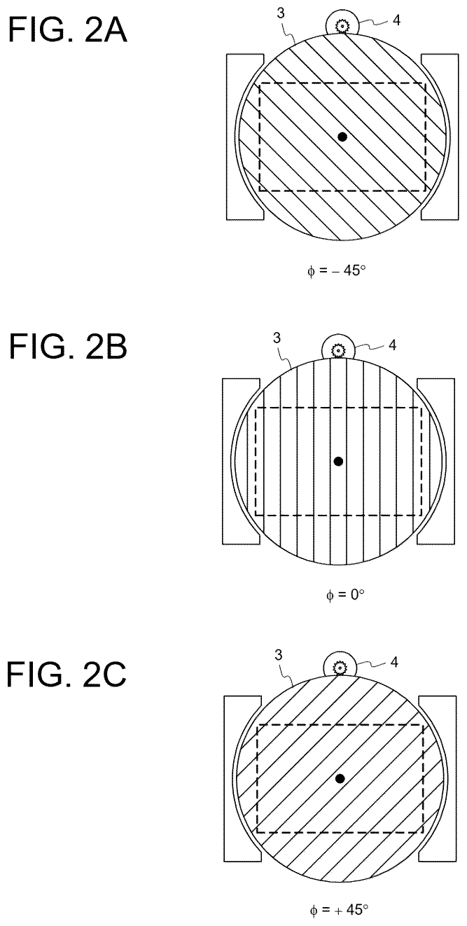

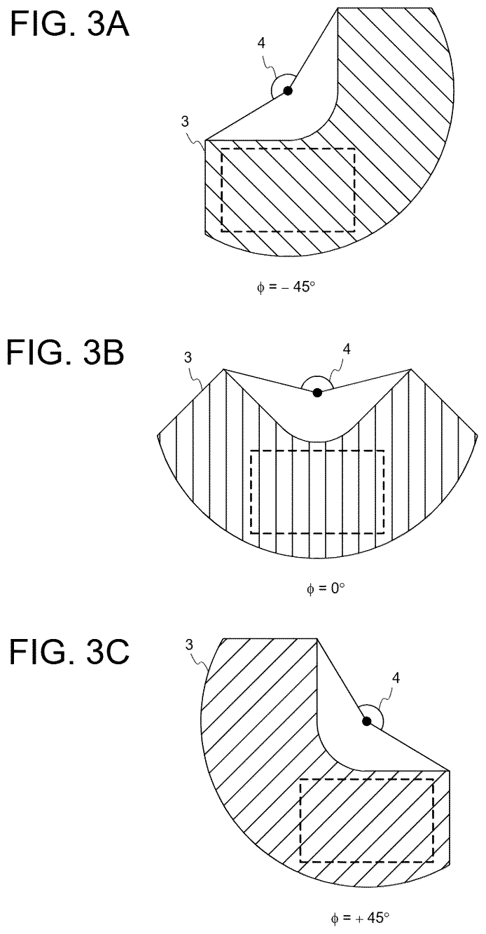

Examples of the filter rotation mechanism are shown in FIG. 2A, FIG. 2B, and FIG. 2C. Provided are the movable polarization filter 3 having a circular shape and a motor and a supporting mechanism positioned on the outer circumference thereof for rotating the movable polarization filter 3. The supporting mechanism is capable of supporting the movable polarization filter 3 from the left and the right and has, for example, a roller (not shown) that is in contact with the movable polarization filter 3. The rectangle drawn with a broken line indicates an imaged area, whereas the black dot indicates a rotation axis. Because the rotation axis is in the imaged area, it is not possible to provide a physical rotation axis. This scheme has an advantage where it is possible to minimize the size and the installation space of the movable polarization filter 3.

A different example of the filter rotation mechanism is shown in FIG. 3A, FIG. 3B, and FIG. 3C. Provided are the movable polarization filter 3 having a fan shape and a motor and a supporting mechanism positioned at the base thereof for rotating the movable polarization filter 3 in the manner of a pendulum. The rectangle drawn with a broken line indicates an imaged area, whereas the black dot indicates a rotation axis. This scheme has an advantage where the mechanism and the control are simple because the supporting mechanism that rotates together with the movable polarization filter 3 is fixed to the rotation axis. Although the motor is provided at the rotation axis in FIG. 3A, FIG. 3B, and FIG. 3C, it is also acceptable to provide a motor on the outer circumference of the movable polarization filter 3.

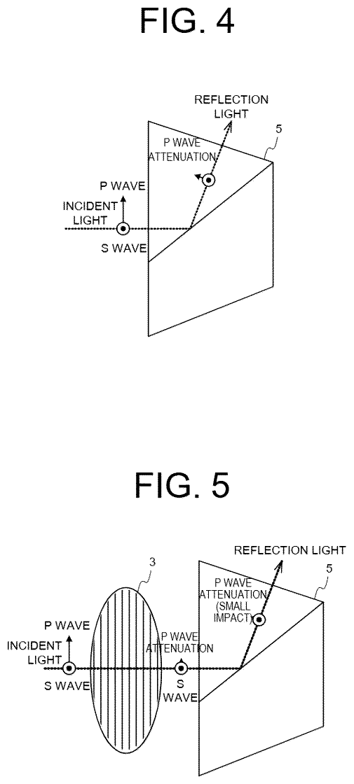

FIG. 4 shows an example of reflection light reflected by the color separation optical system according to the first embodiment. FIG. 5 shows examples of the polarization by the movable polarization filter and reflection light reflected by the color separation optical system. In the multi-plate imaging device 1, as shown in FIG. 4 and FIG. 5, a P-wave component of the reflection light may be greatly attenuated by reflection within the color separation optical system 5 in some situations. Accordingly, it is desirable to set a reference angle 0°of the movable polarization filter 3 so that the polarization is oriented toward an S-wave component with respect to the reflection direction of the color separation optical system 5. In this situation, the reference angle 0°denotes an angle used as a reference for the rotation of the movable polarization filter 3.

The fixed polarization filter 6R is installed on a front face of the image sensor 7R at an angle of −θ with respect to the reference angle 0° of the movable polarization filter 3. Similarly, the fixed polarization filter 6B is installed on a front face of the image sensor 7B at an angle of +θ with respect to the reference angle 0° of the movable polarization filter 3.

In this situation, when the rotation angle of the movable polarization filter 3 is expressed as q, the red light reaching the image sensor 7R via the movable polarization filter 3 and the fixed polarization filter 6R is reduced to cos(φ+θ) . Similarly, the blue light reaching the image sensor 7B via the movable polarization filter 3 and the fixed polarization filter 6B is reduced to cos(θ−θ).

In other words, for the red light and the blue light, when the deviation in the angle between the movable polarization filter 3 and the fixed polarization filter 6R, 6B is 0°, the entire light passes without being reduced. As the deviation increases, the light reduction amount increases. When the deviation reaches 90°, the light is entirely blocked. The green light is not impacted by the angles of the movable polarization filter 3.

In this manner, in imaging environments having a low color temperature, it is possible to increase the light reduction amount of the red light, while keeping the light reduction amount of the blue light small, by controlling the filter rotation mechanism 4 so as to rotate the movable polarization filter 3 in the +θ direction. Conversely, in imaging environments having a high color temperature, it is possible to increase the light reduction amount of the blue light, while keeping the light reduction amount of the red light small, by rotating the movable polarization filter 3 in the −θ direction.

In this scheme, the light reduction amounts of the red light and the blue light are traded off with each other and therefore cannot coexist. Also, there is no light reduction function for the green light. However, light sources that require light reduction control are primarily reddish light having a low color temperature or bluish light having a high color temperature. Thus, it is very unlikely to have a greenish or purplish light source. For this reason, it is safe to say that this scheme is compliant with practical applications of the imaging device 1.

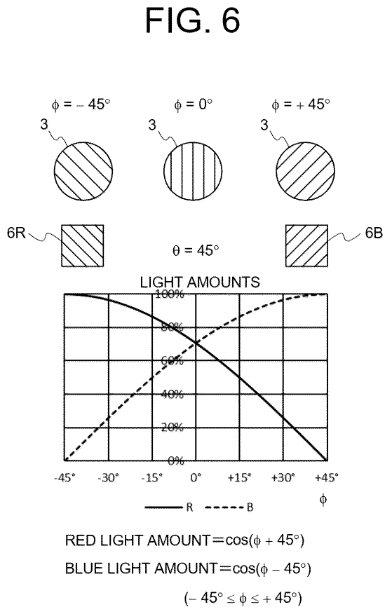

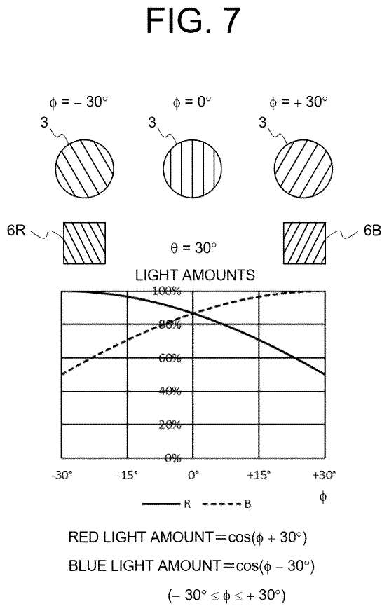

FIG. 6 and FIG. 7 show a relationship, at the angle θ, between rotation angles of the movable polarization filter and light reduction amounts of red light and blue light. A maximum rotation angle of the movable polarization filter 3 and the angle θ of the fixed polarization filters 6R and 6B are arbitrary. For example, when θ=45° is satisfied as shown in FIG. 6, when the movable polarization filter 3 is set with the blue-side maximum angle +45°, while the blue light is not reduced, the red light is completely blocked. Although a wide dynamic range for the red light can be expected, even when the rotation angle is set to 0° in the hope of not reducing neither the red light nor the blue light, it turns out that both are reduced by 1/√2 times. Accordingly, it is necessary to determine the angle θ, while taking the light reduction amounts in a steady state (when the rotation angle is 0°) into consideration.

Further, although FIG. 1 shows the example in which the imaging device is of a three-plate type, the imaging device may be of a four-plate type by which the green light is further split into two.

As explained above, according to the first embodiment, it is possible to realize an imaging device having a wide dynamic range by solving the problems of multi-plate imaging devices related to costs, installation space, flexibility, filter product lifespans, color afterimages, and the like.

Further, by setting the reference angle 0°of the movable polarization filter so that the polarization is oriented toward the S-wave component with respect to the reflection direction of the color separation optical system, it is possible to minimize the impact where the P-wave component of the reflection light is greatly attenuated by the reflection within the color separation optical system.

### Second Embodiment

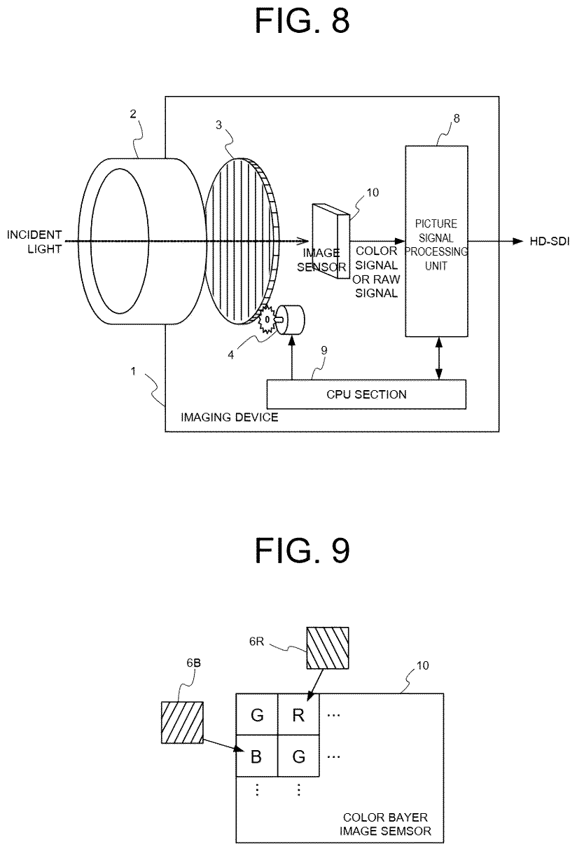

FIG. 8 is a block diagram showing an exemplary configuration of a single-plate imaging device according to a second embodiment.

FIG. 8 shows a structure obtained by removing the color separation optical system 5 from the configuration of the first embodiment, and further replacing the plurality of fixed polarization filters 6R and 6B and the monochrome image sensors 7R, 7G, and 7B with a single image sensor 10 having a color Bayer array. The image sensor 10 is capable of outputting a raw signal or a color signal converted from a raw signal.

FIG. 9 shows color filters of the image sensor and fixed polarization filters according to the second embodiment. The image sensor 10 according to the present embodiment is, as shown in FIG. 9, an image sensor in which, in addition to the color filters arranged in the color Bayer array, the fixed polarization filters 6R angled at −θ with respect to the reference angle 0° of the movable polarization filter 3 are installed for the red color filters; and the fixed polarization filters 6B angled at +θ with respect to the reference angle 0° of the movable polarization filter 3 are installed for the blue color filters.

Other operation examples and principle schemes are the same as those in the first embodiment.

As explained above, according to the second embodiment, by solving the problems of single-plate imaging devices related to costs, installation space, and the like, it is possible to realize an imaging device that is seamless, is highly flexible, and has a wide dynamic range, which has otherwise been difficult to be realized due to technical constraints of liquid crystal filters and electronic shutters.

A number of embodiments of the present invention have thus been explained; however, the present invention is not limited by the embodiments described above. It is possible to apply various modifications thereto without departing from the gist of the present invention.

### REFERENCE SIGNS LIST

1: imaging device, 2: lens, 3: movable polarization filter, 4: filter rotation mechanism, 5: color separation optical system, 6R: fixed polarization filter, 6B: fixed polarization filter, 7R: image sensor, 7G: image sensor, 7B: image sensor, 8: picture signal processing unit, 9: Central Processing Unit (CPU) section, 10: color Bayer image sensor

1. A multi-plate color imaging device comprising:
a movable polarization filter that polarizes incident light;
a rotation mechanism that rotates the movable polarization filter with respect to an optical axis; and
a fixed polarization filter installed at a prescribed angle on a front face of an image sensor that receives red light and blue light, wherein
the red light and the blue light are reduced according to a rotation angle of the movable polarization filter.

2. The multi-plate color imaging device according to claim 1, wherein
a reference angle of the movable polarization filter is set so that the polarization is oriented toward an S-wave component with respect to a reflection direction of a color separation optical system.

3. A single-plate color imaging device comprising:
a movable polarization filter that polarizes incident light;
a rotation mechanism that rotates the movable polarization filter with respect to an optical axis; and
an image sensor having a color Bayer array in which a polarization filter positioned at a prescribed angle is installed with red and blue color filters, wherein
red light and blue light are reduced according to a rotation angle of the movable polarization filter.
